(19) United States
(12) Patent Application Publication
(10) Pub. No.: US 2010/0306656 A1
(43) Pub. Date: Dec. 2, 2010

(54) Digital media asset management

(75) Inventors: Sean T. Moloney, Plainfield, NJ (US); Ron Chu, Northampton, MA (US); Michael Tierney, Greenwich, CT (US); Nicolas R. Tierney, New York, NY (US)

Correspondence Address: Leason Ellis LLP, 81 Main Street, Suite 503, White Plains, NY, 10601, US

(73) Assignee: Dramatic Health, Inc., New York, NY (US)

(21) Appl. No.: 12/761,630

(22) Filed: Apr. 16, 2010

Related U.S. Application Data
(60) Provisional application No. 61/217,591, filed on Jun. 1, 2009.

(51) Int. Cl. G06F 3/00; G06F 17/30

(52) U.S. Cl. 715/723; 707/770; 707/E17.12

(57) ABSTRACT

This invention comprises a system and a method for managing a plurality of video assets via code executing in a processor. The system and method include a user interface, a controller configured to receive metadata associated with the plurality of video assets through the user interface, a database communicatively coupled to the controller in order to store the metadata, a sequence generator communicatively coupled to the database to generate a playlist from the metadata, a generator module communicatively coupled to the sequence generator module, wherein the generator module is configured to generate a uniform resource locator address (URL) that points to a playlist comprising related video assets and a communications module for providing the URL to a remote machine.

### CROSS-REFERENCE TO RELATED APPLICATIONS

The present application claims the benefit of U.S. patent application Ser. No. 61/217,591, filed Jun. 1, 2009 which is hereby incorporated by reference in its entirety.

### FIELD OF THE INVENTION

The present invention relates to improvements in video management and more particularly to a computer-implemented system and method for managing video assets for delivery through a distributed computer network.

### BACKGROUND OF THE INVENTION

There are various media assets such as songs and videos available on the Internet and various intranets. Songs and videos can be sources of entertainment, knowledge and education. These and other media assets are sometimes shared through media-sharing websites. Some of these websites allow for media assets to be searched and played back, either through the user's browser or through a standalone or plug-in player. Typical formats for media assets include, but are not limited to, MPEG, MOV, and AVI.

The quality of video and other media assets varies greatly. Some videos are filmed in high definition by expert camera crews. Others are of modest quality filmed by amateurs using home video recorders. In medical videos, the quality and composition of a video asset is of paramount importance to convey the intended message honestly and fully, and to comply with fairness disclosure requirements of the US Federal Government.

When videos are published on a website, they are individually selectable and playable independently of one another. For example, when a user is watching a first video through a website and clicks on a second video during playback, the first video is stopped midstream and the second video loads for playback. The viewer then loses his or her place in the first video and is now shown the second video (or a control to start the second video). It would be beneficial to improve upon such interfaces and video management systems to enable videos to be played in a serial manner based on user interaction. Further, it would be beneficial to play videos in a sequence as selected by the user, and for users to be able to share sequences of related videos they generate with one another.

The present invention addresses these and other needs.

### SUMMARY OF THE INVENTION

According to one aspect of the invention, a computer-implemented system for managing a plurality of video assets utilizes a controller module comprising code executing in a processor. A user interface and a controller module cooperate to receive metadata associated with a plurality of video assets. A database is communicatively coupled to the controller to store the metadata. A sequence generator module is communicatively coupled to the database to generate a playlist of related video assets from the metadata. A generator module is communicatively coupled to the sequence generator module and is configured to generate a uniform resource locator address (URL) that points to the playlist. A communications module provides the URL to a remote machine.

According to another aspect of the invention, an article of manufacture for managing a plurality of video assets includes an electronically accessible medium that utilizes the instructions executed by a processor. The instructions cause the processor to select the plurality of video assets and associate metadata associated with the selected video assets. The metadata include a sequence for each of the selected video assets and generate a playlist from the metadata associated with the selected video assets. A uniform resource locator address processes the playlist based on the metadata.

According to another aspect of the invention, a computer-implemented method for managing a plurality of video assets includes the step of selecting through a user-interface one or more related videos assets from the plurality of video assets. A sequence of the selected video assets is associated relative to one another. The sequence is definable through the user-interface. A playlist is generated by using a playlist module executing in the computer on the basis of the sequence associated with the selected video assets. A uniform resource locator address (URL) is generated by using a URL module executing in the computer to point to the playlist. A remote machine communicates with the generated URL by using a communications module. To ensure that the videos in a playlist are all related, the computer-implemented method will include a tag-analysis module that makes sure that all the videos in the playlist have at least one common metadatum. This common metadatum or common tag is often a word or phrase describing the sequence of videos. For example, if a playlist comprises several videos about arthritis treatment, “arthritis” or “arthritis treatment” might be the common metadatum. Alternatively, the common metadatum might be a common name of the video, a common producer, a common actor or any other information stored in the video asset metadata. Persons having ordinary skill in the relevant art will recognize many ways in which a computer program ensuring that each video in a playlist has at least one common metadatum or tag can be written. If a user tries to create a playlist comprising a set of video assets all of which do not share at least one common metadatum or common tag, the tag-analysis module will notify the user through the user interface that the playlist needs to be modified because the videos in the playlist are unrelated. As discussed in the detailed description below, the tag-analysis module might also suggest to the user through the user interface some modifications to ensure that this requirement is met.

According to another aspect of the invention, a computer-assisted method for managing a playback of a plurality of video assets includes selecting for playback through a user-interface one or more videos from the plurality of video assets. The selected videos are associated with the selected metadata that include a sequence of selection of the videos through the user-interface. The selected videos are arranged in a playback queue based on the metadata. The selected videos are played from the queue in the arrangement established by the metadata.

These and other aspects, features, and advantages of the invention can be appreciated from the accompanying drawing figures and discussion of certain embodiments of the invention.

### BRIEF DESCRIPTION OF THE DRAWINGS

FIG. 1 illustrates a portion of a user interface associated with a production application being utilized for healthcare video management in accordance with an embodiment of the invention.

FIG. 1A illustrates a schematic system diagram for a video management system in accordance with an embodiment of the invention.

FIG. 2 illustrates another portion of the user interface of an embodiment of the production application of FIG. 1, showing details of a description tab.

FIG. 3 illustrates another portion of the user interface of an embodiment of the production application of FIG. 1, showing details of a meta tab.

FIG. 4 illustrates another portion of the user interface of an embodiment of the production application of FIG. 1, showing details of a distribution tab.

FIG. 5 illustrates another portion of the user interface of an embodiment of the production application of FIG. 1, showing details of an access tab.

FIG. 6 illustrates another portion of the user interface of an embodiment of the production application of FIG. 1, showing details of a descriptor tab.

FIG. 7 illustrates another portion of the user interface of an embodiment of the production application, showing details of a credit tab.

FIG. 8 illustrates another portion of the user interface of an embodiment of the production application of FIG. 1, showing details of a music tab.

FIG. 9 illustrates another portion of the user interface of an embodiment of the production application of FIG. 1, showing details of a note tab.

FIG. 10 illustrates another portion of the user interface of an embodiment of the production application of FIG. 1, showing details of a save as tab.

FIG. 11 illustrates another portion of the user interface of an embodiment of the production application of FIG. 1, showing details of an encode selection.

FIG. 12 illustrates another portion of the user interface of an embodiment of the production application of FIG. 1, showing details of a playlist selection.

FIG. 13 illustrates a portion of a user interface of an embodiment of the playback application being utilized for healthcare video management In accordance with an embodiment of the invention.

FIG. 14 illustrates another portion of the user interface of an embodiment of the playback application of FIG. 13, showing details of the user interface for playback application.

FIG. 15 is a flowchart illustrating a computer-implemented method for managing production of a plurality of video assets in accordance with an embodiment of the invention.

FIG. 16 is a flowchart illustrating a computer-assisted method for managing playback of a plurality of video assets in accordance with an embodiment of the invention.

### DETAILED DESCRIPTION OF CERTAIN EMBODIMENTS OF THE INVENTION

Embodiments of the invention described herein are generally directed to a computer-implemented system and a method for managing a plurality of video assets that utilizes a controller module comprising code executing in a processor. A hosted production application and a playback application are described as two components of a system in accordance with one embodiment of the invention. The purpose of the production application is to enable a user to manage his or her video assets, such as healthcare video assets. The production application provides functionality suitable for associating metadata, preparing the video assets for distribution across multiple Internet sites, and generating detailed reports on video management, subscription, registration and other details associated with the video assets.

The playback application includes a full-featured video player that can be optimized for playback of healthcare video assets. The playback application accepts video assets catalogued in the production application, and can integrate with other video management tools. Through the playback application's interface, the user can search, characterize, select, tag and manage videos assets. The playback application includes a query-based video search function. The search results can be obtained using various parameters such as metadata associated with the video assets. The selected videos can be viewed in a High Definition format. According to an aspect of the invention, the selected videos can be grouped as a playlist comprising videos all having something in common defined by the user. To ensure that the videos in a playlist are all related to one another, a tag-analysis module will make sure that all the video assets in the playlist have at least one common metadatum or tag. This common metadatum or common tag might be a word describing the video asset, such as “arthritis” or “brain surgery.” Alternatively, it might be the title of the video or the name of an actor or producer or any other information stored in the metadata of the video asset. Persons having ordinary skill in the relevant art will recognize many ways such a tag-analysis module might be programmed. If a user tries to create a playlist comprising videos that do not all share at least one common metadatum or common tag, the tag-analysis module might suggest to the user through the user interface some modifications to ensure that this requirement that all the video assets in the playlist share at least one common metadatum or common tag is met. For example, if a suggested playlist comprises ten video assets, nine of which have the tag “eyes,” the tag-analysis module could suggest that the video lacking the “eyes” tag be removed. Alternatively, if eight of the ten video assets are produced by Jane Doe, the tag-analysis module might suggest removing the two videos that are not produced by Jane Doe. The purpose of this tag-analysis module is to ensure that all the video assets are related to a common theme or have something in common, and are not simply a random collection of unrelated video assets. After a playlist is created, it is made available for the user who created it to view himself or herself or to share with others. In one embodiment of the invention, the playlist is also accessible to other users through a uniform resource locator address (URL) or through a search engine. The playback application can also be used independently of the production application.

The production application has been developed as a hosted application and is known as “Backstage,” a product of Dramatic Health, Inc., the present assignee. The playback application also has been developed as a hosted application and is known as “OnStage,” which is also a product of the present assignee.

The video assets are categorized as clips, segments or episodes. A clip is a video asset of short duration, on the order of 1-2 seconds in length. An episode comprises several clips and is roughly 1-2 minutes in length. A segment comprises several episodes, lasting around 10 minutes.

There are various metadata that are associated with the videos. The metadata include attributes or tags of the video asset. The metadata identify and characterize the videos and allow for efficiently searching the videos. The metadata may include: a name of the video, a name of a producer, a date of production, an access rights, a duration of a video, a thumbnail such as a still or a frame representing the video, a key word and other meta-tagging information for search engine optimization purposes, comments from viewers of the videos, and other user defined information about the video. Programs for generating and storing the metadata, as well as playing the videos, may be written in one or more computer languages, such as C, C++, XML, UNIX, JAVA, etc.

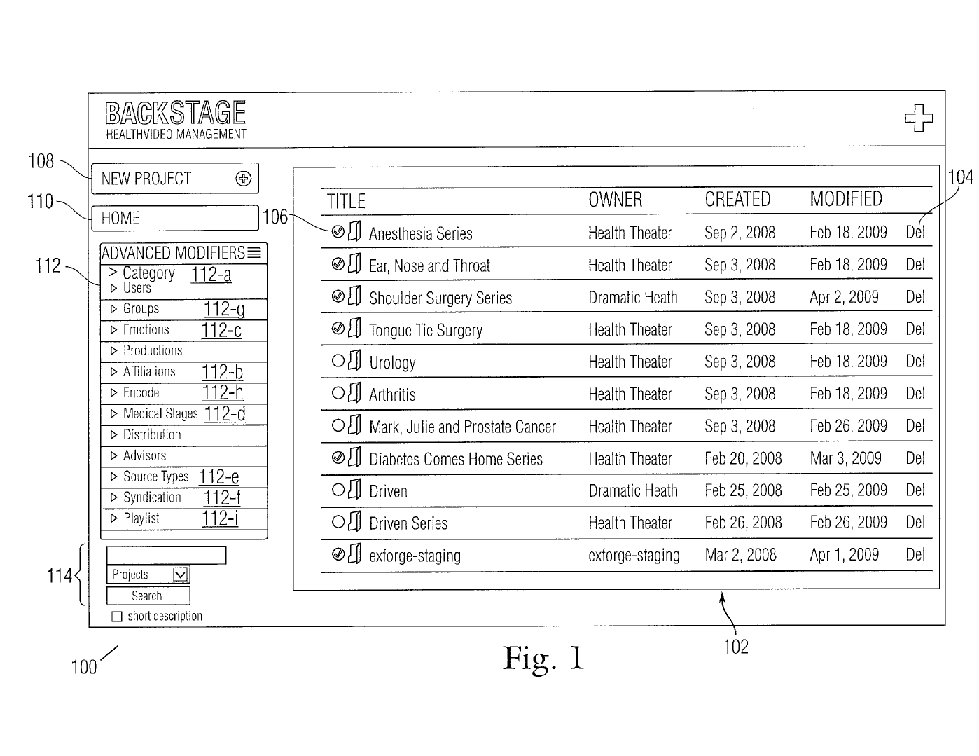

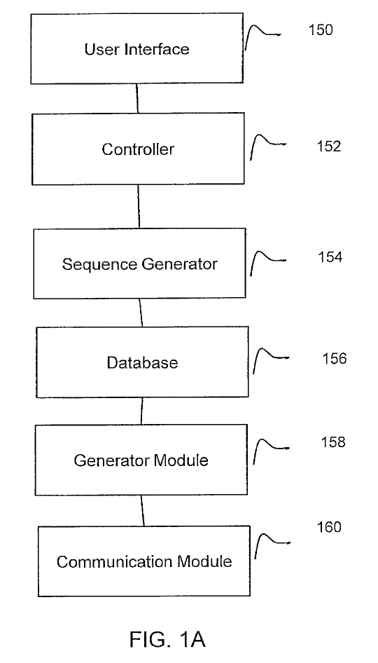

FIGS. 1-13 illustrates an example of a user interface 100-1300 for hosting, managing and viewing the video assets. The system and method include multiple interface screens arranged to be accessed in response to interaction with an interface component selected for use by the user. The arrangement of FIG. 1A can be used to implement a system that includes the user interfaces of FIGS. 1-13.

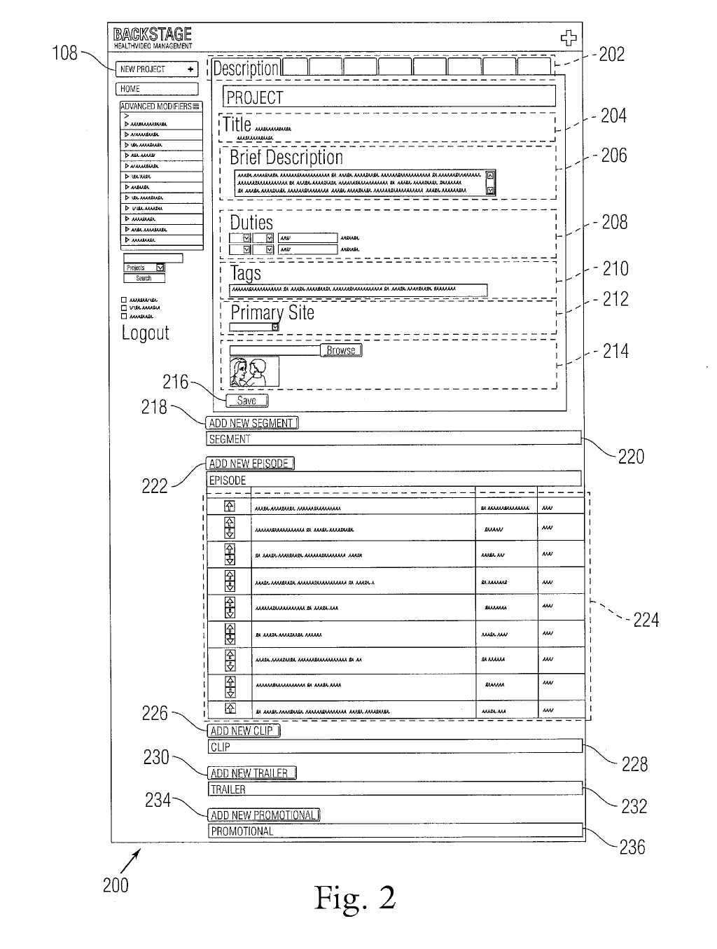

FIG. 1 illustrates a user interface 100 for a production application applied to a healthcare video management sector in accordance with an embodiment of the invention. The user interface 100 can be provided when the user selects a credits tab from tabs 202 (FIG. 2A) for the project. A user can upload, organize, manage, view and share his or her videos through the user interface 100. The production application of the invention allows the user to manage the video assets and the metadata associated with the videos. The production application enables the user to prepare the video assets for distribution across multiple Internet sites. Furthermore, the user can generate detailed reports and statistics on views, subscriptions, registrations and other data associated with the performance of all, or any group of, the video assets. FIG. 1 contains a list of video assets 102. The list of video assets 102 contains an example of various video assets that are available with the production application and various details associated with the video assets. The details can include, but are not limited to, a title of the video, an owner of the video, a creation date of the video and a modification date of the video. The title field includes the identification name of the video. The owner field includes the name or user ID of the creator of the video. The created field includes the date the video was created and the modified field includes when the video was modified. FIG. 1 can be explained with an example: the list of video assets 102 includes a checkbox 106 to select or de-select a video from list of video assets 102 for processing. One video asset 102 includes the title: ‘Anesthesia Series’, the owner: ‘HealthTheater’, the creation date: ‘Sep. 2, 2008 ’, and the modification date: ‘Feb. 18, 2009 ’. The list of video assets 102 may further contain a delete button 104 to delete video assets in the list.

The list of video assets 102 may contain a new project button 108, a home button 110, a set of advanced modifiers 112, and a search box 114. The new project button 108 allows the user to add the new project. The new project may contain various video assets and the metadata related to the video assets. The creation of a new project and the use of metadata is discussed in detail in conjunction with FIG. 2. The home button 110 allows the user to navigate to a main page from any other page of the website. The advanced modifiers 112 provide control functionality and can be configured as a controller to receive the metadata associated with the plurality of video assets through the user interface. As such, the controller manages the metadata characterized by the user interface. The metadata includes identification of the plurality of video assets. The advanced modifiers 112 control various operations and may include, but not limited to, category 112-a, users 112-m, groups 112-g, emotions 112-c, productions 112-e, affiliations 112-b etc. The functionality of the advanced modifiers 112 can be explained with an example. The user may select other users or groups to have viewing rights to particular video assets. Similarly, the user can select the productions 112-e tab to modify the productions detail for a specific video, such as time the video was created, modified, the metadata used to identify the production details and the like. The user can encode the video, add source tags, and generate playlist by selecting an appropriate button from among the advanced modifiers 112. The user can use the encode 112-h tab to add text in the video or a message or graphics in the video to be shown when the video is played. Further, user can encode the video for higher resolution or change the format of the video. Thus characterization of the video assets can be done by using the advanced modifiers 112. The search box 114 allows the user to search for videos by using search queries such as a keyword, a combination of keywords, a string of words or a Boolean search. A specific project can be selected from the drop-down menu to be searched as shown in the search box 114. The search box 114 may also allow the user to search in various sections or metadata of the videos such as, description of the videos, the title, the tag, the attributes, the data, the creator, the title, the owner and so forth. The effectiveness of the search query is based on various attributes of the video including keywords, a meta-tag, the metadata, the transcript, the title, a health stage, medical conditions, etc. For example, the results of the search with a keyword ‘anesthesia’ may include videos that contain the keyword in the title, the description or the metadata of the video.

FIG. 1A illustrates a hardware arrangement 101. The hardware arrangement 101 is the system for managing the plurality of video assets via code executing in a processor. The system includes the user interface 150. A controller module 152 is configured to receive metadata associated with the plurality of video assets through the user interface 150. The controller 152 manages the metadata characterized using the user interface 150. A database 154 is communicatively coupled to the controller 152 in order to store the metadata. The database 154 can be either in the production or the playback application. The database 154 includes the metadata, the video assets and other relevant information of the video, users, programming codes, etc. The database 154 can be connected to the Internet or intranet to share the data. A sequence generator module 156 can be communicatively coupled to the database 154 to generate a playlist from the metadata. A generator module 158 is communicatively coupled to the sequence generator module 156 so that the generator module 158 can generate a uniform resource locator address (URL) that points to the playlist. The URL generated by the generator module 158 plays the playlist. A communications module 160 provides the URL to a remote machine. The playlist can be further modified after received by the remote machine. The metadata may include identification of the plurality of video assets. The generated playlist may be sequentially played as selected by the user through the user interface 150.

FIG. 2 illustrates the user interface 200 of the production application. A project description tab 202 is selected to provide the user interface 200. The tabs 202 are selected to provide an organized interface for adding, editing or deleting various metadata of a project or the video. The tabs 202 can include, but not limited to, a description box, a meta box, a distributor box, an access box, a descriptor box, a credit box, a music box, an advisor note box and a note box. The user using the user interface 200 can select the description tab, as shown in the display interface 202. The description box on the tab 202 may contain a title box 204 that may include the title of the video, such as “Anesthesia Series”. In the title box 204, the information regarding the video or the project can be entered to identify the video. The user may be allowed to put a maximum of 120 or some other arbitrary number of characters in the title to identify the video or the project so that the title of the video or the project is precise and short for understanding. Further, the description box on the tab 202 may include a brief description box 206. The brief description box 206 may include a short description of the video or the project. The user may be allowed to put a maximum of 255 or some other arbitrary number of characters in the brief description. The date selector 208 is a drop down menu that allows the user to select dates associated with the project. In an embodiment of the invention, date associated with the project can be the date on which the project was captured. In another embodiment of the invention, date associated with the project can be the date on which the project was published or is scheduled to be published online. The tag box 210 allows the user to define various tags associated with the project. The tags provide additional information related to the title 204. For example, the title 204 is “Anesthesia Series” and the brief description box 206 explains may include information about the video asset “Anesthesia Series”. The tag box 210 defines keywords that allow search engines to locate “Anesthesia Series”. Therefore, the tags enable the project or video assets to be searched for a query. The tags may be separated with commas, colons, hyphens, etc. The site selector box 212 is a drop down menu that allows the user to select a primary site to be associated with the project. In an embodiment of the invention, a primary site is a website where the video assets are displayed. The preview selector box 214 is a file upload box that allows the user to select a preview image for the project. Examples of the file include an image file, a video frame, a thumbnail of the video or the image file. In an embodiment of the invention, the user can select the file for uploading from his or her local device. The save button 216 allows the user to save the details provided for the project. For example, in the user interface 200, the save button 216 can save the title, the description, the dates, the tags, the site and the preview for the project.

FIG. 2A is a combination of FIGS. 2-9 connected along matched lines A-2, A-3 . . . A-9. The user interface 200A in FIG. 2A further contains a segment button 218. The segment button 218 allows the user to add a new segment, such as segment 220, to the playlist. The segment 220 can be a single video asset with a play duration of ten minutes or longer. The segment 220 can further provide the list of segments available for the project. The segment 220 can be a specially produced compilation of thematically linked episodes. The segment can be a specially produced compilation of thematically linked episodes and a clip can be a portion of an episode with a play duration of a few seconds. Similarly, an episode button 222 allows the user to add a new episode, such as the episode 224. The episode 224 may be an independent video asset with play duration of between one and two minutes in length. Similar to the episode button 222, a clip button 226, a trailer button 230 and a promotional button 234 allows the user to add new episode, clip, trailer, promotional video respectively to episode 224, clip 228, trailer 232 and promotional 236.

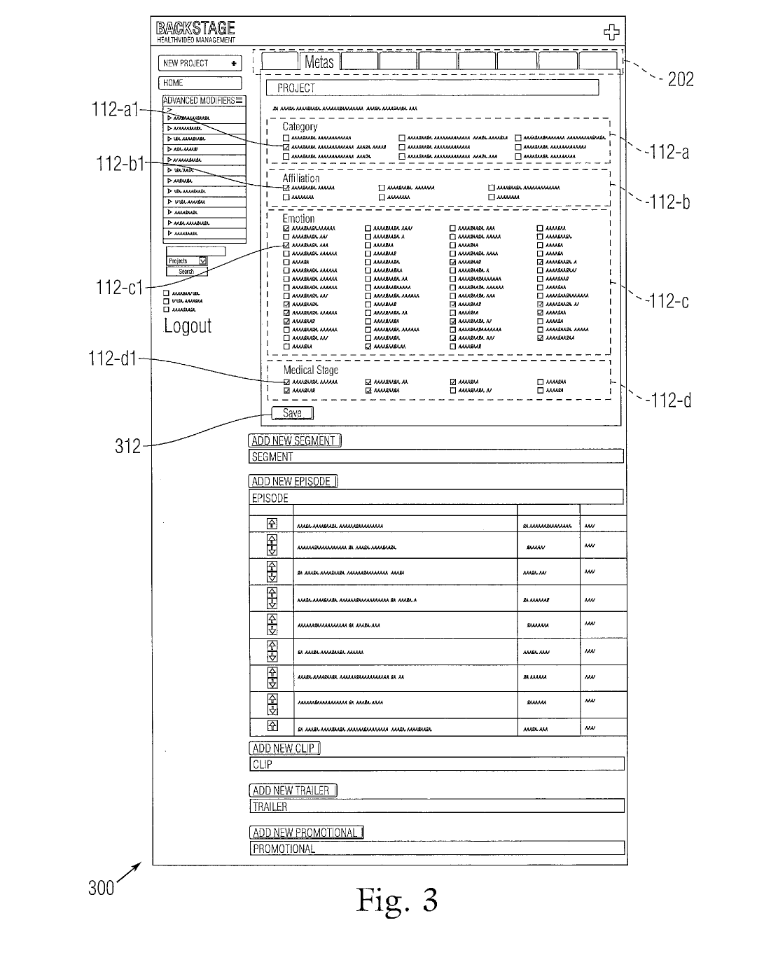

FIG. 3 illustrates the user interface 300 containing the meta tab 202 for the production application along with the project 108 as applied to healthcare video management sector in accordance with an embodiment of the invention. The user interface 300 is provided when the user selects the meta tab from tabs 202 for the project, in an embodiment of the invention. The meta tab includes the project 108 and various metadata as disclosed in FIG. 3 such as the category 112-a, affiliation 112-b, emotion 112-c, and medical stage 112-d. Each checkbox in 112-a, 112-b, 112-c, 112-d as disclosed represents the information describing the video and various categories that can be associated with the video assets of the project. In an exemplary embodiment consumer education production 112-a1 metadata checkbox is selected to represent the category metadata 112-a. Examples of categories include, but are not limited to, biotech productions, consumer education productions, pharmaceutical productions, talk show productions and so forth. Similarly, academia 112-b1 checkbox is selected to represent the affiliation metadata 112-b, anxiety 112-c1 checkbox is selected to represent the emotion 112-c metadata, and symptoms 112-d1 checkbox is selected to represent the medical stage 112-d metadata. Examples of affiliation groups include, but are not limited to, academia, government, media, biotech, user and so forth. Similarly, the emotion 112-c metadata may include various emotions that can be associated with the video assets. In an embodiment of the invention, various emotions can be selected from the checkboxes provided in the emotions 112-c metadata. Examples of emotions include acceptance, anxiety, fear, surprise, submission, and so forth. Similarly, the medical stage 112-d metadata can include various stages that can be associated with the video assets. In an embodiment of the invention, various stages can be selected from the checkboxes provided in the medical stage 112-d metadata. Examples of stages for include, but are not limited to, symptoms, diagnosis, treatment, recovery, and so forth. The save button 302 allows the user to save the details provided for the project in the database 154. Once all the 112-a, 112-b, 112-c, 112-d and other related metadata are defined for a specific project the process can be automated for other related videos.

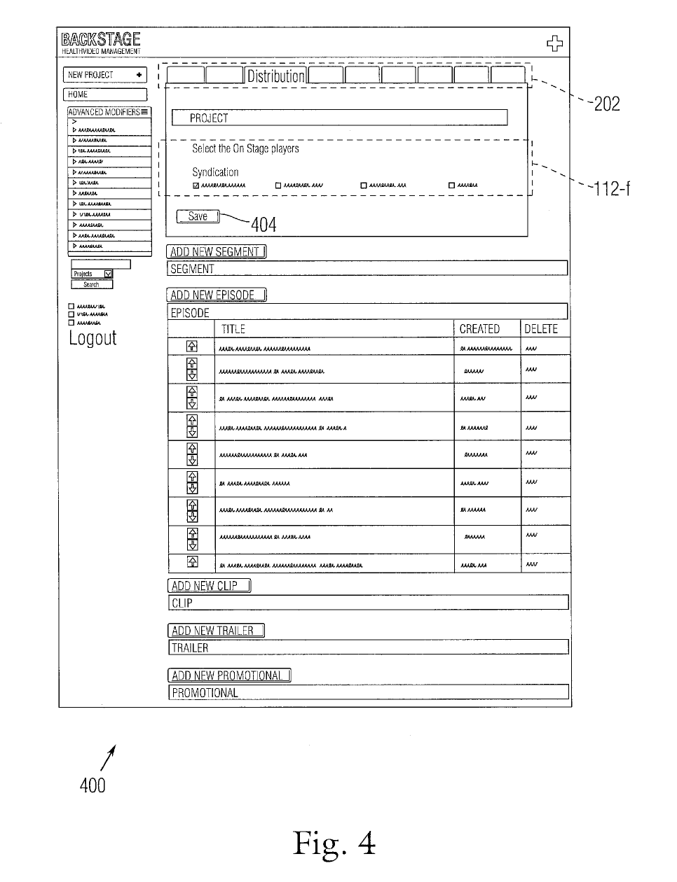

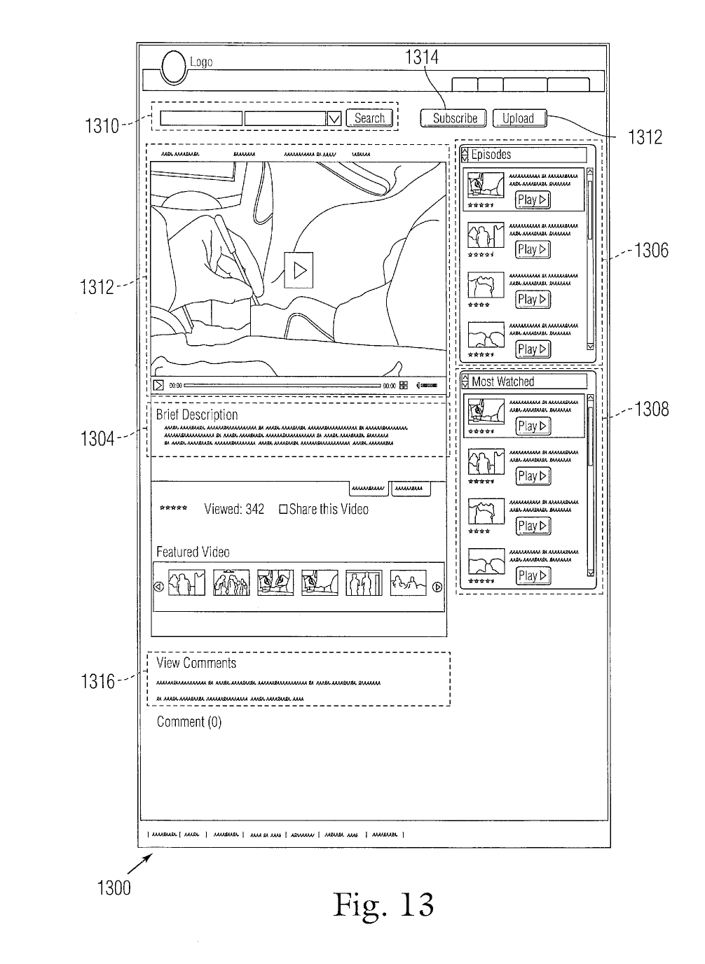

FIG. 4 illustrates the user interface 400 containing the distribution tab 202 for the production application. The video assets associated with the project 108 are managed through the production application and can be published online on multiple Internet websites through the playback application of the invention. The playback application includes various websites and players where the videos can be viewed by the user. The playback application is discussed in detail in conjunction with FIG. 13. Examples of players that can be selected from the metadata include the syndications 112-f player. The syndications 112-f include Dramatic Health, ExForge, Health Theatre and so forth. The save button 404 allows the user to save the details provided for the project and to save the selected checkboxes and other detailed related to them to the database 154.

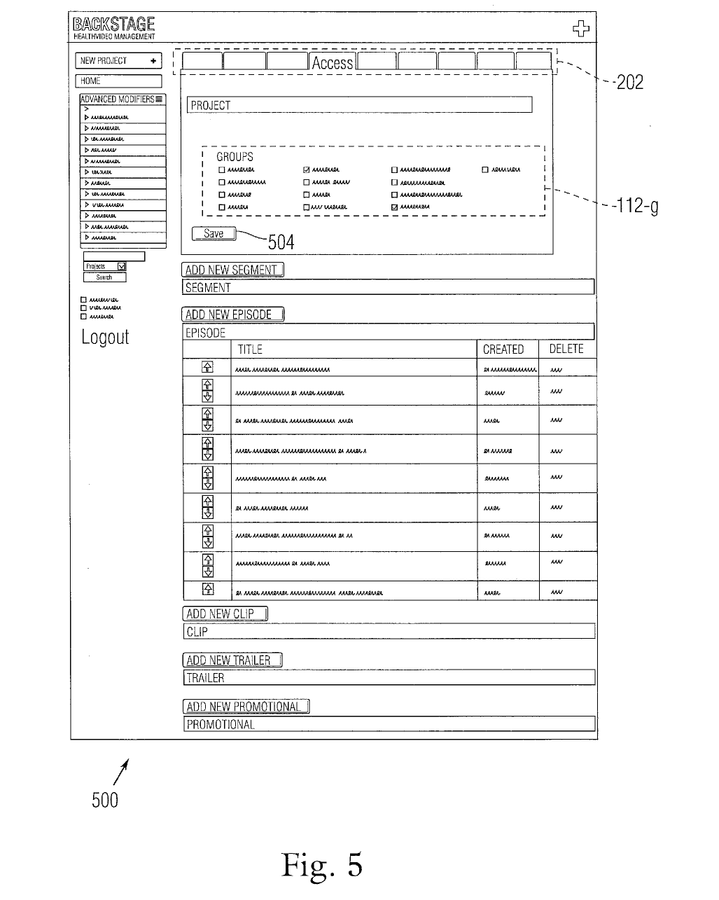

FIG. 5 illustrates the user interface 500 containing the access tab on the tab 202 for the production application along with the project 108 as applied to healthcare video management sector in accordance with an embodiment of the invention. The user interface 500 is provided when the user selects the access tab from the tabs 202 for the project. The metadata on the access tab 202 may include the group 112-g to provide access to a specific group. The user can provide the access to these groups of video assets. For health-related videos, examples of access groups include advisor, administrator, industry, education, legal reviewer, vendor and so forth. In an embodiment of the invention, more groups can be added to the group 112-g. In another embodiment of the invention, the access level provided to the access group is defined by the type of group. For example, an administrator may have access to edit or delete the video assets, whereas a legal reviewer may only have access to provide comments on the video assets. In yet another embodiment of the invention, the level and type of access for the access groups can be changed. The save button 504 allows the user to save the details provided for the project and to save the selected checkboxes and other detailed related to them in the database 154.

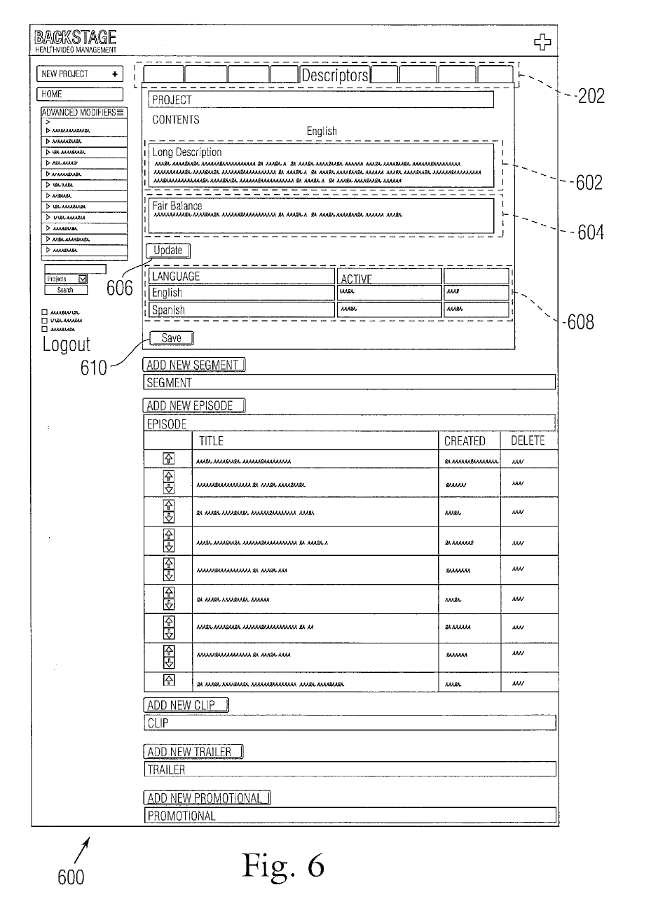

FIG. 6 illustrates the user interface 600 containing the descriptor tab 202 for the production application along with project 108 as applied to the healthcare video management sector. The user interface 600 is provided when the user selects the descriptor tab 202 for the project, in an embodiment of the invention. The metadata on the descriptor tab on the tab 202 may include the long description box 602. The long description box 602 allows the user to provide additional information and detail related with the project. For example, the long description box 602 can include the name of the actor, a discussion of and reasons for the symptoms, and so forth. A fair balance box 604 allows the user to provide a fair balance statement of the project. For example, a fair balance statement for a medical video could suggest that the legal language has been locked to the video asset. The update button 606 allows the user to update the long description and fair balance statement associated with the video assets. In one embodiment of the invention, the update button 606 allows the user to append or add additional descriptions and fair balance statements. The language selector 608 provides a list of languages in which a user can write the information regarding the video in various tabs 202. Furthermore, the language selector 608 allows the user to update the language of the video assets. The save button 610 allows the user to save the details provided for the project and save the selected checkboxes and other details related to them to the database 154.

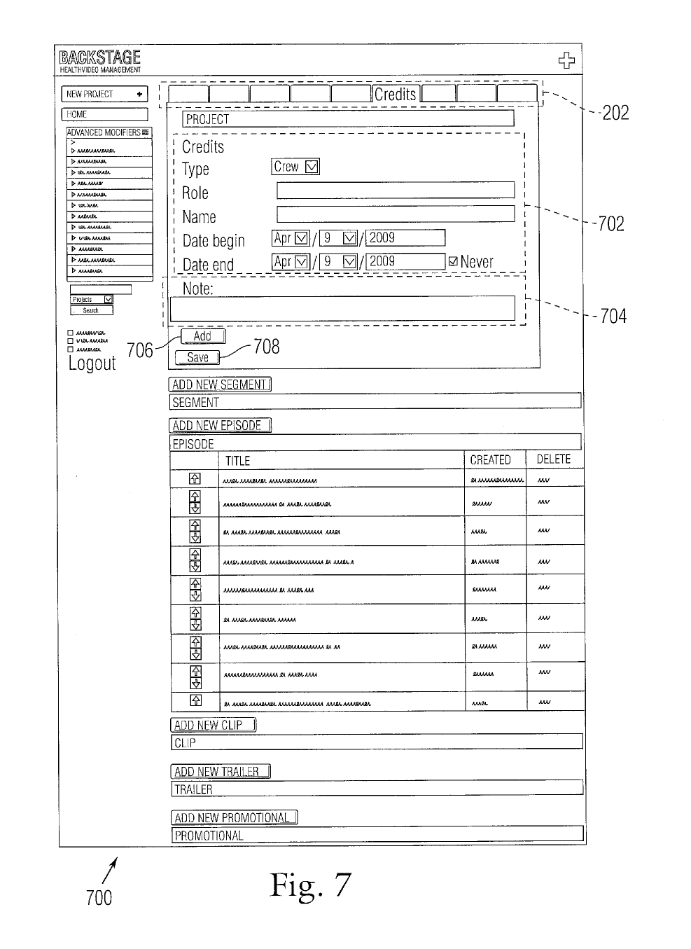

FIG. 7 illustrates the user interface 700 for the credits tab 202 for the production application along with project 108 as applied to healthcare video management sector in accordance with an embodiment of the invention. The user interface 700 is provided when the user selects the credits tab from tabs 202 for the project. The user interface 700 includes a credits group 702, a notes box 704, an add button 706 and a save button 708. The credit group 702 includes the details of the user who is credited with the uploading, reviewing or managing the video assets. Credit group 702 includes various details such as the type, role, and name of the user. Further credit group 702 includes the start and end dates for the role of the user. Examples of the type of a user can be crew, user, doctor and so forth. Examples of roles can be uploader, reviewer and so forth. The notes box 704 is a text box that allows the user to add notes regarding a credited person. For example, the notes may contain the profession, qualification, address, contact or any other information related to the credited person. The add button 706 allows the user to add the credit details and notes for the video assets. In an embodiment of the invention, more credit details and notes can be added after add button 706 is pressed. The save button 708 allows the user to save the details provided for the project and save the selected checkboxes and other detailed related to them to the database 154.

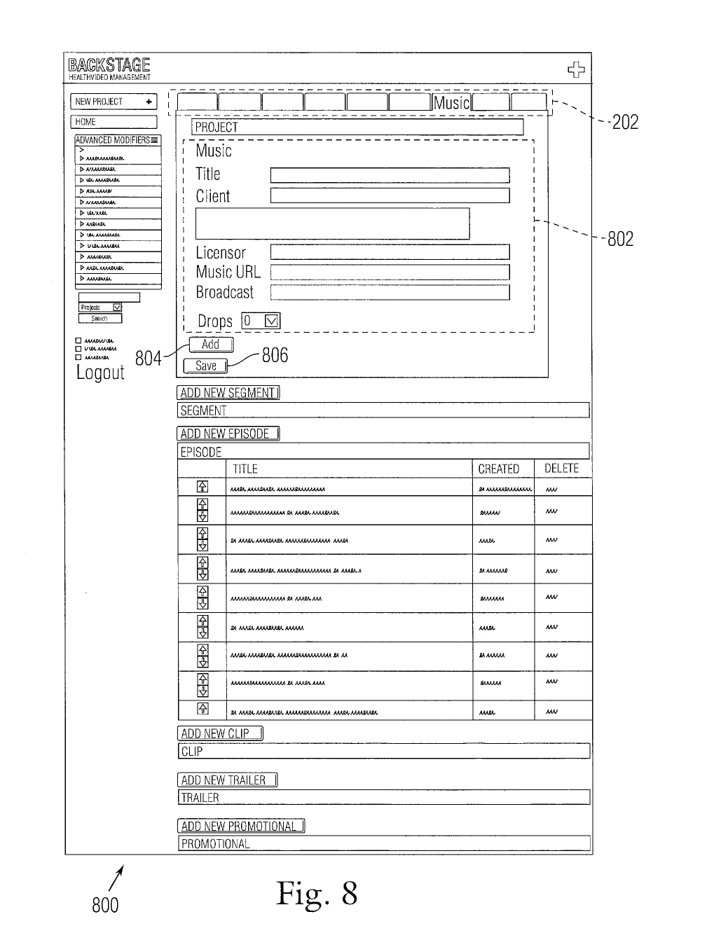

FIG. 8 illustrates the user interface 800 containing the music tab 202 of the production application along with project 108 as applied to healthcare video management sector in accordance with an embodiment of the invention. The user interface 800 is provided when the user selects a music tab from tabs 202 for the project. The user interface 800 includes a music group 802, an add button 804 and a save button 806. This allows the user uploading the video to select the music one would hear while viewing the video. The music group 802 includes the details associated with the music for the video asset. The music details include the title of the music, a client information, a licensor information, the Uniform Resource Locator. (URL), broadcast and drop. The add button 804 allows a user to add these details to the video assets. In an embodiment of the invention, more details can be added after add button 804 is pressed. The save button 806 allows the user to save the details provided for the project and save the selected checkboxes and other detailed related to them to the database 154.

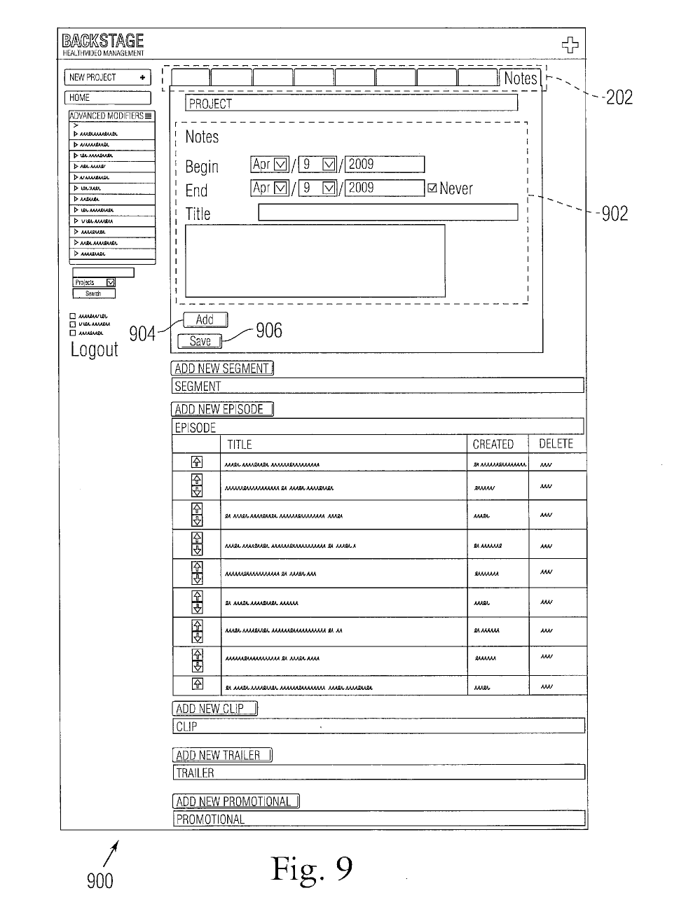

FIG. 9 illustrates the user interface 900 containing the notes tab on the tab 202 of the production application along with project 108 as applied to healthcare video management sector in accordance with an embodiment of the invention. The user interface 900 is provided when the user selects a notes tab 202 for the project. The user interface 900 includes a project notes group 902, an add button 904 and a save button 906. Notes can be added to describe the project 108. The notes group 902 includes begin and end dates, a title, and other details. The add button 904 allows a user to add these details to the project. In an embodiment of the invention, more details can be added after add button 904 is pressed. The save button 806 allows the user to save the details provided for the project and save the selected checkboxes and other detailed related to them to the database 154.

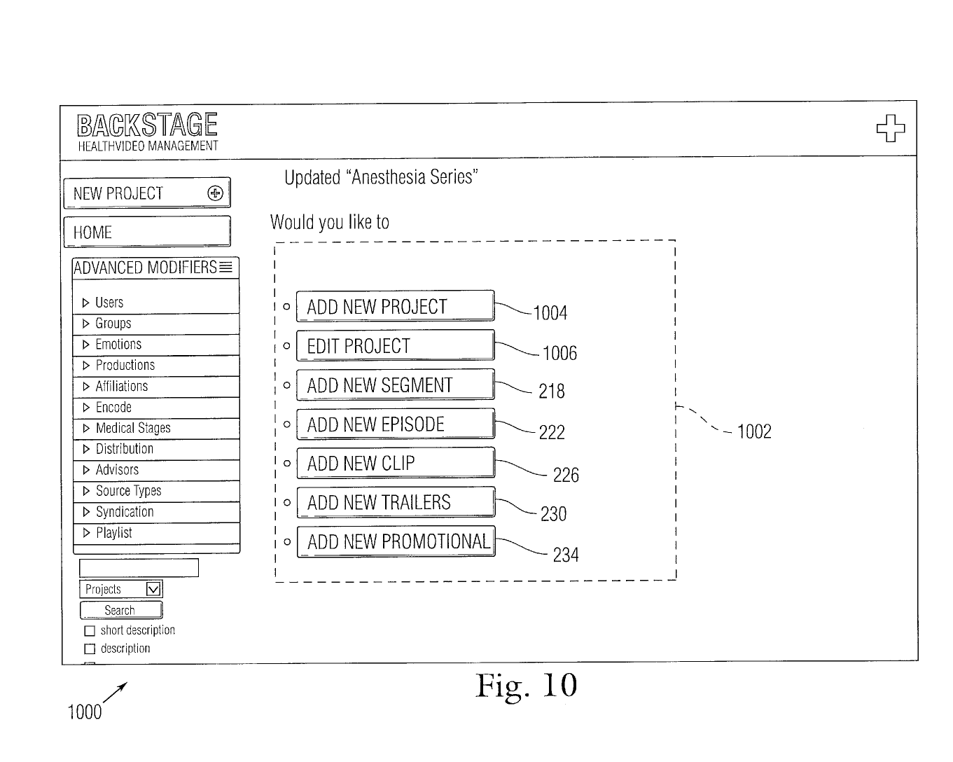

FIG. 10 illustrates the user interface 1000. The user interface 1000 is provided when a project is uploaded in the production application, in accordance with an embodiment of the invention. In another embodiment of the invention, the user interface 1000 is provided before starting a new project. In yet another embodiment of the invention, the user interface 1000 is provided after the project is published for viewing on the network. The user interface 1000 includes a button group 1002 for adding, editing a new project and the like. Therefore, an existing project can be edited by pressing an edit project button 1006. A new project can be added by pressing an add new project button 1004. Similarly, a new segment, episode, clip, trailer, or promotional can be added by pressing segment button 218, episode button 222, clip button 226, trailer button 230 and promotional button 234 respectively.

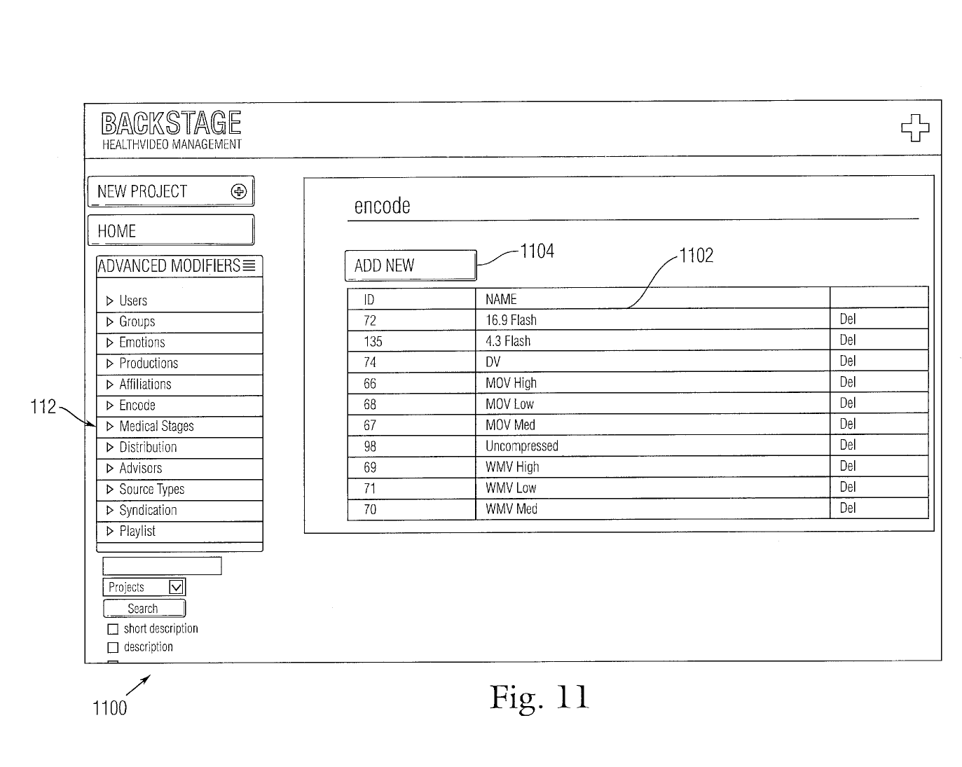

FIG. 11 illustrates the user interface 1100 of the production application along with encode selection as applied to healthcare video management sector in accordance with an embodiment of the invention. The user interface 1100 is provided when the user selects the encode button 112-h from advanced modifiers list 112. The video selected by the user from the video assets can be encoded by clicking in on the encode button 112-h. The encode button 112-h encodes the video assets in multiple media formats. The user interface 1100 includes an encode list 1102. The encode list 1102 includes the listing of various media formats available for encoding the video assets. Examples of media formats include, but are not limited to, flash, MOV, WMV, their variants, and so forth. The add new button 1104 allows a user to add new formats for video assets. For example, the user may choose to encode MOV files into Flash files, which is a compressed format used for on-line video streaming. The media format may be represented by ID's and the chosen format can be later deleted if required by the user.

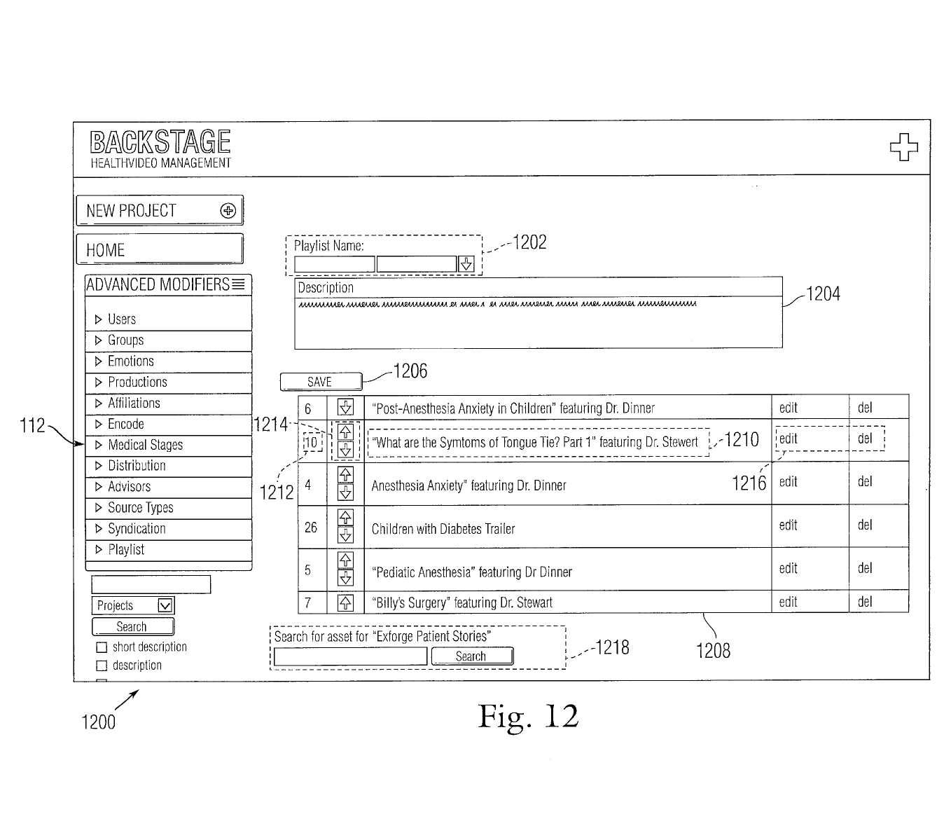

FIG. 12 illustrates the user interface 1200 of the production application with a playlist selection as applied to healthcare video management sector in accordance with an embodiment of the invention. The production application allows the user to create a playlist from the video assets. The user interface 1200 is provided when the user selects the playlist button 112-i from the advanced modifiers list 112. The user interface 1200 includes a playlist name box 1202, playlist description box 1204, a save button 1206, a playlist group 1208, a video title 1210, sequence number 1212, a sequence selector 1214, an edit button 1216, and search box 1218. The playlist name box 1202 allows the user to provide a name for the playlist. Furthermore, the playlist name box 1202 allows the user to select a playback player for the playlist. The playlist description box 1204 is a text box that allows the user to provide a description for the playlist. For example, the description may include information regarding the type and contents of the video assets in the playlist. The playlist group 1208 includes multiple video assets that are selected by the user. The video title 1210 is the title or name of a video asset. The sequence number 1212 is a number associated with the video asset, which decides the order in which the video asset should be played in playlist 1208. For example, a video asset with a sequence number ‘10 ’ is played after a video asset with a sequence number ‘6 ’. In other embodiments of the invention, the sequence number 1212 can include a numbers, alphabet or ASCII character or the like, comprising the name of the video, the name of the producer, the date of production, access rights, duration of video, and other custom attributes. The sequence selector 1214 can change the sequence number of the video assets. As shown in FIG. 12, an up arrow in sequence selector 1214 may decrease the sequence number and a down arrow may increase the sequence number. The edit button 1216 allows a user to edit the title of the video assets. Furthermore, edit button 1216 allows a user to delete the video asset from playlist 1208. The search box 1218 allows the user to search for videos by using search queries such as a keyword, combination of keywords, string of words or Boolean search. The search result may be obtained using various parameters such as the metadata from the database 154. The save button 1206 allows the user to save the playlist group 1208 and other related data and metadata to the database 154. Of course, the user's ability to save the playlist is limited to playlists wherein all the videos have at least one common metadatum to ensure that playlists represent related video entries.

In an embodiment of the invention, the save button 1206 generates a URL for the playlist group 1208 after using the tag-analysis module to ensure that all the videos in the playlist group have at least one common metadatum. The URL of the playlist can be shared with other users or viewers on the network. In an embodiment of the invention, a receiver of the URL can edit playlist 1208, video assets and attributes associated with the video assets, provided, of course, that all videos the receiver adds also share at least one common metadatum with the existing videos in the playlist.

In an embodiment of the invention, the save button 1206 generates a URL for the playlist group 1208. The communication module 160 provides the URL to a remote machine. The communication module 160 and the remote machine may be a PDA, cellular device, computer or the like.

FIG. 13 illustrates the user interface 1300 of the playback application as applied to healthcare video management sector in accordance with an embodiment of the invention. The playback application includes a full-featured video player. The playback application seamlessly accepts video assets catalogued from the production application, and integrates with other video management tools. The playback application enables the user to easily and simultaneously provide a viewer a fully-featured High Definition (HD) video viewing experience. The playback application further provides a video search functionality. Furthermore, the playback application might allow the viewers to upload their own videos. In an embodiment of the invention, the playback application can also be used independently of the production application. The playback application allows the user to access information related to viewership, registration and subscriptions of videos assets. The user interface 1300 is an exemplary screenshot of the playback application. The user interface 1300 includes a video player 1302, a description panel 1304, an episode thumbnail list 1306, a most watched thumbnail list 1308, a search box 1310, an upload button 1312, a subscribe button 1314, and a comment box 1316.

The video player 1302 enables viewing of videos. In an embodiment of the invention, the video player 1302 enables viewing of videos on a 16×9 HD screen or some similar device. The video player 1302 may enable the viewer to view the video in a full screen mode. Furthermore, the video player 1302 may enable the viewer to play, pause or stop the video and control other video functionalities. Examples of other video functionalities include time indication and volume controls. The description panel 1304 provides additional details such as the metadata associated with the videos. For example, the description panel 1304 may include the video format, time of creation, time of modification, author or creator. The details regarding the video may also include indications of medical condition and treatment path in case of a medical video, publisher, date of publication, etc. The description panel 1304 may include information such as ratings of the video, view numbers, and so forth. The episode thumbnail list 1306 provides thumbnails of episodes associated to the video being played in video player 1302. In an embodiment of the invention, episode thumbnail list 1306 may include related videos that are presented automatically for selection based on the videos selected by the user. The related videos are presented based on attributes associated with the videos selected by the user. Most watched thumbnail list 1308 provides thumbnails of the frequently viewed videos associated with the video being played in video player 1302.

In an embodiment of the invention, the user interface 1300 displays a playlist selected by the viewer. While playing a playlist, the video player 1302 caches a next video to be played while playing a current video. As a result, delays in the buffering of videos are avoided. In an embodiment of the invention, caching and similar mechanisms, such as those provided by Akamai™ Technologies, may be used to cache and stream videos to ensure the most efficient viewing experience.

The search box 1310 enables a viewer to search for videos using search queries and keywords. Videos can be searched based on attributes associated with the video in the production application. The upload button 1312 enables the viewer to upload his or her own videos. In an embodiment of the invention, the videos may be encoded in a particular video format before uploading. In another embodiment of the invention, attributes may be associated with the videos before uploading. The subscribe button 1314 allows the viewer to subscribe to the videos or updates. The subscribe button 1314 allows the viewer to create an account for viewing the videos of his or her interest. The subscription to the video assets allows the viewer to view reports associated with the project. The report can include statistics on the activities associated with the videos in the project. The report can contain information on the format, directory, geography and referrer of the video, number of users, average duration, bandwidth and so forth. In an embodiment of the invention, the report can be exported in eXtensible Markup Language (XML) or a Comma Separated Version (CSV) formats. In another embodiment of the invention, the report may be generated in a raw format to be used in other applications.

The viewers of videos can put their comments on the video in comment box 1316. In an embodiment of the invention, comment box 1316 includes the comment, name and email identifier of the viewer.

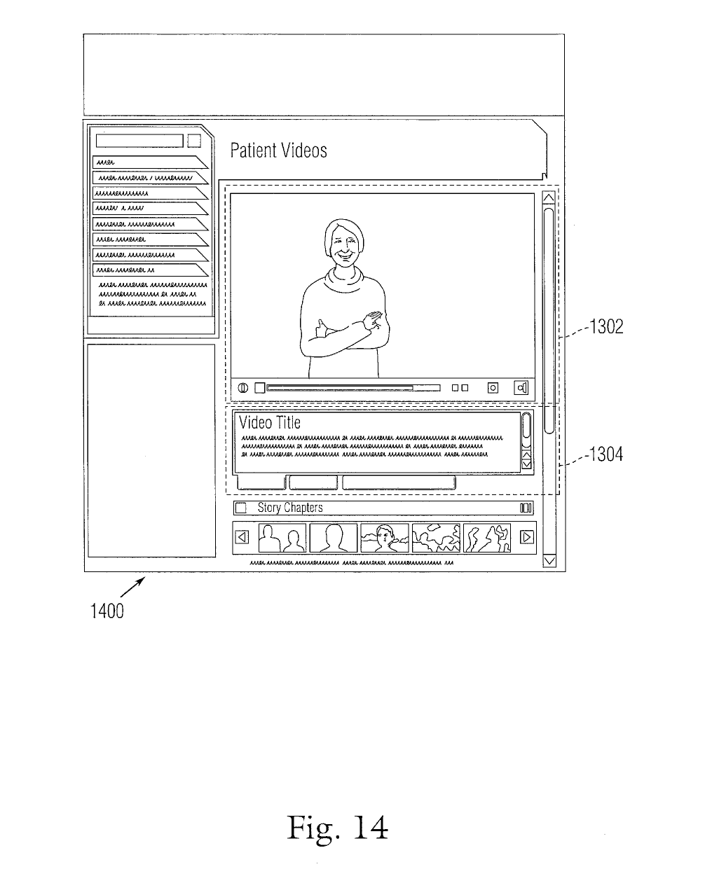

FIG. 14 illustrates the user interface 1400 of the playback application on a web portal as applied to healthcare video management sector in accordance with an embodiment of the invention. The playback application enables the video player 1302 to be incorporated into the web portal of a website. The playback application enables the video player 1302 on the website without changing the associated page art and branding as provided by the publisher or owner of the website. The video player 1302 can be enabled on the website by providing a Hyper Text Markup Language (HTML) link to the users account, in an embodiment of the invention. Moreover, the playback application enables the viewer to perform searches for videos from the external site. The videos can be embedded in the external site by generating an HTML code from the production application. EXtensible Markup Language (XML) feeds can be used to enable the video player.

As shown in FIG. 14, the user interface 1400 includes the video player 1302 on an external web site. The external web site is a website that the user is authorized to display the video assets. The authorization comes form the administrator of the service. The description panel 1304 provides additional details such as the metadata associated with the videos.

In another embodiment of the invention, an article of manufacture for managing a plurality of video assets may include an electronically accessible medium including instructions, that when executed by a processor, cause the processor to select the plurality of video assets. The metadata may be associated with the selected videos, wherein the metadata include a sequence for each of the videos. Further, playlists, videos, uniform resource locator addresses, etc. can be generated from the metadata.

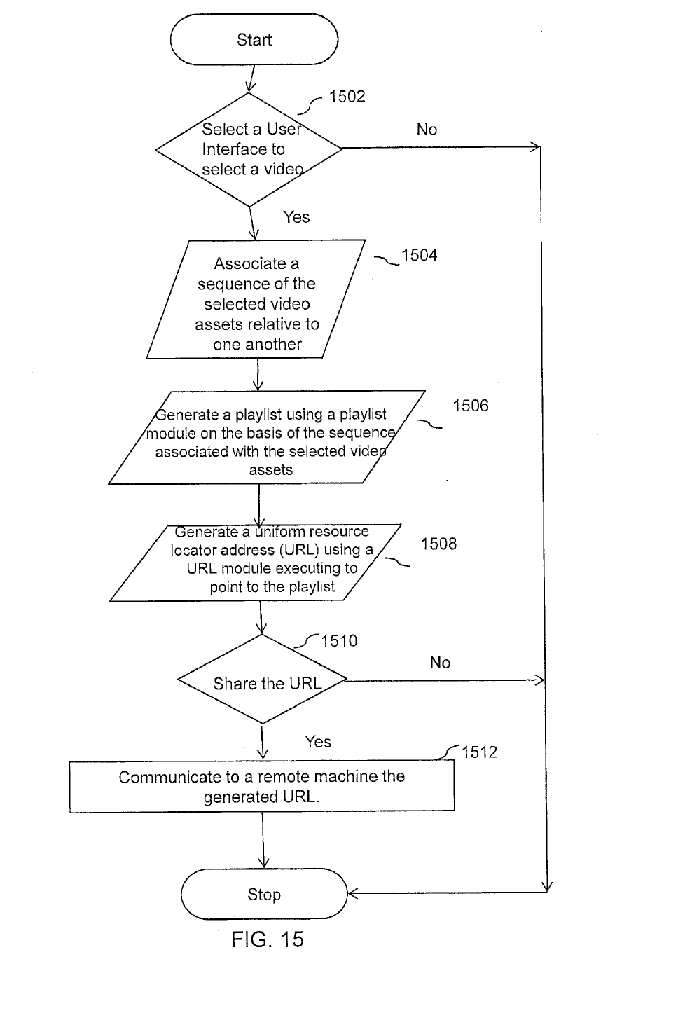

FIG. 15 depicts a flowchart of a computer-implemented method for managing a plurality of video assets in an embodiment of the invention. At step 1502, a user selects, through the user-interface 150 of a computer, one or more videos from the plurality of video assets. At step 1504, a sequence is associated for the selected video assets relative to one another. The sequence is defined through the user-interface 150. In an embodiment of the invention, the sequence may include a sequence number for the video, wherein the sequence number may include a keyword, ASCII or combination or the like. Examples of video assets include, but are not limited to, name of the video, name of the producer, date of production, treatment path, name of the physician, fair balance language, fair balance requirements, special instruction, access rights, duration of the video, ratings, subscriptions and so forth. The video assets are received from the user by the user interface 150 (FIG. 1A). The video assets are associated with the metadata by using the production application. The metadata can be received by using the controller 152. The metadata can be stored in the database 154 that can be communicatively coupled to the controller 152 and the sequence generator module 156. The metadata are processed by the sequence generator module 156 to generate a playlist of videos sharing at least one common metadatum or tag. The metadata may be the attribute or a tag used to characterize and identify the video assets. The sequence generator module 156 is communicatively coupled to the database 154 to generate the playlist from the metadata. Subsequently, at step 1506, the playlist may be generated using the playlist module executing in the computer on the basis of the sequence associated with the selected video assets. The selected video assets are played one after another in the selected sequence. The playlist includes playing the one or more videos by caching one or more videos based on the sequence associated with the selected video assets. In an embodiment of the invention, the playlist is generated from the sequence number attribute associated with the videos. The playlist is in the form of a queue of the videos based on selection sequence. In an embodiment of the invention, one or more videos are played on the basis of the sequence associated with the selected video assets. Thereafter, at step 1508, a Uniform Resource Locator (URL) address is generated using a URL module executing in the computer to point to the playlist. The generator module 158 may be communicatively coupled to the sequence generator module 156. In an embodiment of the invention, the sequence of the selected video assets may be modified and a new URL can be generated. The URL might be generated based on the sequence numbers associated with the videos. At step 1510, the user can choose to share the URL and at step 1512, the generated URL is communicated to a remote machine by the communications module 160. Therefore, the URL of the playlist can be shared with viewers on the Internet, allowing them to view the videos. In an embodiment of the invention, the URL of the playlist can be shared with the viewers that are authorized by the user in the production application. The URL of the playlist can be used to add, edit or delete the videos in the playlist based on the access rights defined by the user in the production application. In an embodiment of the invention, the videos in the playlist are executed seamlessly without any buffering delays as the next video is cached while the current video is playing.

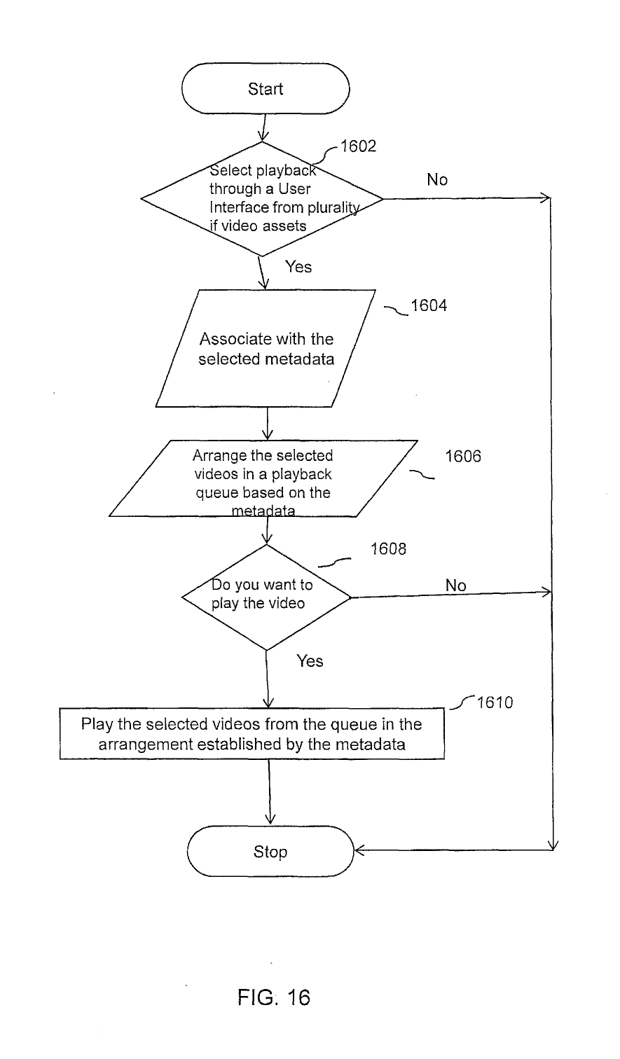

FIG. 16 is a flowchart of computer-assisted method for managing a playback of a plurality of video assets in accordance with another embodiment of the invention. At step 1602, a user selects for playback through a user-interface one or more videos from the plurality of video assets. In an embodiment of the invention, related videos are presented automatically for selection based on the videos selected by the user. The related videos are presented based on attributes associated with the videos selected by the user. Thereafter, at step 1604 the selected metadata are associated that may include a sequence of selection of the videos through the user-interface. Subsequently, at step 1606, the selected videos may be arranged in the playback queue based on the metadata. The playlist is generated based on the metadata. In an embodiment of the invention, the playlist is generated from the sequence number associated with the videos. The playlist is in the form of a queue that may include the videos arranged based on the sequence number associated with the videos. For example, a video with a sequence number ‘8 ’ is arranged after a video with a sequence number ‘7’.

At step 1608, the user can decide to play the video. At step 1610, the selected videos are played from the queue in the arrangement established by the metadata. Therefore, a next video in the playlist is cached while a current video in the playlist is executed. For example, when a current video with a sequence number ‘7 ’ is being executed or played, a next video with a sequence number ‘8 ’ is cached. As a result, delays in buffering of the next video are avoided and the next video is played seamlessly after the current video. In an embodiment of the invention, the next two videos are cached simultaneously based on the available bandwidth of a viewer. In an embodiment of the invention, the caching is enabled by the playback application. Caching mechanisms, such as those provided by Akamai™ Technologies, can be used to cache and stream videos. The uniform resource locator address (URL) may be generated and associated with the queue based on the metadata, wherein the step of playing the selected videos is in response to entering the URL in a navigation bar of a browser.

Elements of embodiments of the present invention may also be provided as a machine-readable medium for storing the machine-executable instructions. The machine-readable medium may include, but is not limited to, a flash memory, an optical disk, a CD-ROM, a DVD ROM, a RAM, an EPROM, an EEPROM, a magnetic or optical card, or other type of machine-readable medium suitable for storing electronic instructions.

The embodiments of the invention are described above with reference to block diagrams and schematic illustrations of methods and systems according to embodiments of the invention. It will be understood that each block of the diagrams and combinations of blocks in the diagrams can be implemented by computer program instructions. These computer program instructions may be loaded onto one or more general purpose computers, special purpose computers, or other programmable data processing apparatus to produce machines, such that the instructions which execute on the computers or other programmable data processing apparatus create means for implementing the functions specified in the block or blocks. Such computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks.

While the invention has been described in connection with what are presently considered to be the most practical and various embodiments, it is to be understood that the invention is not to be limited to the disclosed embodiments, but on the contrary, is intended to cover various modifications and equivalent arrangements included within the spirit and scope of the appended claims.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer-implemented system for managing a plurality of video assets, comprising:
a user interface;
a controller module comprising code executing in a processor of the computer and operative to receive metadata associated with a plurality of video assets through the user interface;
a database communicatively coupled to the controller module to store the metadata;
a sequence generator module comprising code executing in the processor and operative to generate
a playlist comprising one or more video assets from the metadata;
a tag-analysis module comprising code executing in the processor and operative to provide an indication through the user interface in the event of an absence of at least one common metadatum among all the videos in the playlist;
a generator module communicatively coupled to the sequence generator, wherein the generator module is configured to generate a uniform resource locator (URL) address that points to the playlist; and
a communications module providing the URL to a remote machine.

2. The system in claim 1, wherein the common metadatum is a word or phrase describing a theme of the playlist or of all the video assets.

3. The system of claim 1, wherein the controller manages the metadata as characterized by the user interface.

4. The system of claim 1, wherein the metadata comprises identification of the plurality of video assets all of which are available in the database and accessible by a user.

5. The system of claim 1, wherein the database comprises a production application and a playback application.

6. The system of claim 1, wherein the generated playlist is sequentially played.

7. The system of claim 1, wherein accessing the URL generated by the generator causes the playlist to be played.

8. The system of claim 1, further comprising modifying the playlist after it is received by the remote machine.

9. (canceled)

10. (canceled)

11. A computer-implemented method for managing a plurality of video assets, the method comprising:
associating each video asset with a metadata; selecting through a user-interface one or more videos assets from the plurality of video assets;
indicating through the user interface an absence of at least one common metadatum among the selected video assets;
associating a sequence of the selected video assets relative to one another, wherein the sequence is definable through the user-interface;
creating a playlist on the basis of the sequence associated with the selected video assets;
generating a uniform resource locator address (URL) to point to the playlist; and
communicating the generated URL to a remote machine.

12. The method of claim 11, further comprising playing the one or more videos on the basis of the sequence associated with the selected video assets.

13. The method of claim 11, wherein playing the one or more videos assets from the playlist comprises caching one or more videos assets based on the sequence associated with the selected video assets.

14. The method of claim 1, further comprising editing the sequence of the selected video assets and generating a new URL.

15. The method of claim 11, wherein the video assets are characterized using a metadata.

16. The method of claim 15, wherein the metadata comprises identification of the video assets.

17. The method of claim 11, further comprising generating one or more transcripts for the video assets.

18. The method of claim 11, wherein the associating the sequence of the selected video assets comprises categorizing the video assets.

19. The method of claim 11, further comprising encoding the video assets in a specified media format.

20. The method of claim 11, wherein the selected video assets are played one after another in the selected sequence.

21. A computer-assisted method for managing a playback of a plurality of video assets through management of metadata, the method comprising:
selecting for playback through a user-interface one or more videos from the plurality of video assets;
indicating through the user interface an absence of at least one common metadatum among the selected video assets;
associating the selected videos with the selected metadata that includes a sequence of selection of the videos through the user-interface;
arranging the selected videos in a playback queue based on the metadata; and
playing the selected videos from the queue in the arrangement established by the metadata.

22. The method of claim 21, further comprising generating a uniform resource locator address (URL) associated with the queue based on the metadata, wherein the step of playing the selected videos is in response to entering the URL in a navigation bar of a browser.

23. The method of claim 21, further comprising caching a next video from the one or more videos from the playlist, wherein the next video is cached when a current video from the one or more videos in the playlist is being played, wherein the next video is decided based on the sequence of selection of the next video and is then played.
